(19) United States
(12) Patent Application Publication
(10) Pub. No.: US 2020/0388169 A1
(43) Pub. Date: Dec. 10, 2020

(54) UNMANNED AERIAL VEHICLE INFRASTRUCTURE AND AUTONOMOUS NAVIGATION SYSTEM

(71) Applicant: ITC HOLDINGS CORP., Novi, MI (US)

(72) Inventors: Daniel R. Barr, Dubuque, IA (US); Adelaide Pascaris, Commerce Twp., MI (US); John M. Kopinski, Saline, MI (US); Gordon M. Halt, Fenton, MI (US)

(21) Appl. No.: 16/892,957

(22) Filed: Jun. 4, 2020

Related U.S. Application Data
(60) Provisional application No. 62/857,006, filed on Jun. 4, 2019.
(60) Provisional application No. 62/939,167, filed on Nov. 22, 2019.

(51) Int. Cl. G08G 5/00; G08G 5/04; B64C 39/02; G05D 1/00; G05D 1/10

(52) U.S. Cl. CPC G08G 5/0069; G08G 5/0039; G08G 5/045; B64C 2201/141; G05D 1/0022; G05D 1/101; B64C 2201/027; B64C 39/024

(57) ABSTRACT

Aspects of the present disclosure are directed to an unmanned aerial system (UAS) configured to navigate a UAS corridor. The UAS includes a navigation system that includes one or more sensors, configured to gather environmental data, and a computing system configured to navigate the UAS along the UAS corridor. In some embodiments, the UAS may be communicatively coupled to a network infrastructure which facilitates coordination with other UASs within the corridor or network of corridors, and the network infrastructure provides assistance and/or instructions with respect to navigating the UAS corridor (along with other UASs).

### CROSS-REFERENCE TO RELATED APPLICATIONS

This application claims the benefit of U.S. provisional application No. 62/857,006, filed 4 Jun. 2019, which is hereby incorporated by reference as though fully set forth herein.

This application claims the benefit of U.S. provisional application No. 62/939,167, filed 22 Nov. 2019, which is hereby incorporated by reference as though fully set forth herein.

### BACKGROUND

### a. Field

The instant disclosure relates to an infrastructure, and a navigation system, for an unmanned aerial system (“UAS”) network.

### BRIEF SUMMARY

Various embodiments of the present disclosure are directed to an unmanned aerial system including a propulsion unit, a navigation system, and a transceiver. The navigation system is communicatively coupled to the propulsion unit and provides control inputs to the propulsion unit which affect navigation of the unmanned aerial system along an infrastructure corridor. The transceiver is communicatively coupled to the navigation system, communicates a current position of the unmanned aerial system with a remote infrastructure corridor operator, and receives navigational instructions from the corridor operator to facilitate navigation of the unmanned aerial vehicle relative to the corridor and other unmanned aerial systems operating within the infrastructure corridor. In more specification embodiments, the unmanned aerial system further includes a magnetic field sensor that senses a magnetic field emanating from power lines within the infrastructure corridor. The navigation system is communicatively coupled to the magnetic field sensor and navigates the unmanned aerial system along the infrastructure corridor primarily using a signal from the magnetic field sensor indicative of a distance between the unmanned aerial system and the power lines.

Another embodiment of the present disclosure is directed to a method of operating an infrastructure corridor unmanned aerial system management system. The method including the steps localizing the position of a first plurality of unmanned aerial systems within the infrastructure corridor and a second plurality of unmanned aerial systems anticipated to enter the infrastructure corridor, and providing navigational instructions to the first and second plurality of unmanned aerial systems with respect to access and transit through the infrastructure corridor. In more specific embodiments, the method further includes the use of a plurality of overlapping balancing areas to monitor and control access and transit through a plurality of infrastructure corridors within an infrastructure corridor network by the first and second plurality of unmanned aerial systems.

The foregoing and other aspects, features, details, utilities, and advantages of the present disclosure will be apparent from reading the following description and claims, and from reviewing the accompanying drawings. Moreover, the above discussion/summary is not intended to describe each embodiment or every implementation of the present disclosure. The figures and detailed description that follow also exemplify various (additional) embodiments of the present disclosure.

### BRIEF DESCRIPTION OF THE DRAWINGS

Various example embodiments may be more completely understood in consideration of the following detailed description in connection with the accompanying drawings, in which:

FIG. 1 is a graph illustrating a sample ground-level magnetic field intensity from a 69 kV transmission line of a certain construction carrying 112 Amps of peak load;

FIG. 2 is a graph illustrating a sample ground-level magnetic field intensity from a 69 kV electric transmission line of a certain construction carrying 181 Amps of peak load;

FIG. 3 is a graph illustrating a sample ground-level electric field strength in a certain shared electric transmission line corridor;

FIG. 4 is an illustrative example of a dedicated airspace positioned overhead an infrastructure corridor, consistent with various embodiments of the present disclosure;

FIG. 5 illustrates an example unmanned aerial vehicle with a navigation system, consistent with various embodiments of the present disclosure;

FIG. 6 illustrates an example environment of an unmanned aerial vehicle corridor, consistent with various embodiments of the present disclosure;

FIG. 7 illustrates an example environment of an unmanned aerial vehicle navigating along an infrastructure of corridors, consistent with various embodiments of the present disclosure;

FIG. 8 illustrates an example of a networked infrastructure corridor, consistent with various embodiments of the present disclosure;

FIG. 9 is an illustrative example of an infrastructure corridor UAS traffic management system, consistent with various embodiments of the present disclosure;

FIG. 10 is an illustrative example of an infrastructure corridor UAS traffic management system with balancing areas, consistent with various embodiments of the present disclosure;

FIG. 11 is an illustrative example of a market-based infrastructure corridor UAS traffic management system, consistent with various embodiments of the present disclosure;

FIG. 12 is a table illustrating a number of example infrastructure corridor UAS traffic management system constructs which may be established via a market-based system, consistent with various embodiments of the present disclosure;

FIG. 13 is a diagram illustrating the use of facility ratings within an example infrastructure corridor UAS traffic management system, consistent with various embodiments of the present disclosure;

FIGS. 14A and 14B further illustrate diagrammatically the use of facility ratings within an example infrastructure corridor UAS traffic management system, consistent with various embodiments of the present disclosure; and

FIG. 15 is a diagram illustrating various facility rating attributes as determined for three example UASs, consistent with various embodiments of the present disclosure.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” or “sample” as used throughout this application is only by way of illustration, and not limitation.

### DETAILED DESCRIPTION OF EMBODIMENTS

Electric utilities, owners of gas and oil pipelines, railroad companies, telephone companies and other infrastructure companies operate their facilities in vast networks of individual infrastructure corridors, and junctions between corridors, through which goods and services are conveyed to consumers. The infrastructure corridors are present in most regions of the country, and those corridors may provide the land-based assets above which Unmanned Aerial System (“UAS”) traffic may be safely managed. These corridors may be modified or enhanced to facilitate necessary communication and/or control signals to individual UASs operating in the corridor. Communication and sensing may be accomplished via radio frequencies, LIDAR, RADAR, or other means of mostly wireless communication. Communication to/from the UASs provide needed checks and balances required for the safe operation of UAS, for example, operation beyond visual line of sight (“BVLOS”). Moreover, infrastructure corridors may provide the backbone necessary for development of well-defined airspace corridors, and those well-defined airspaces can enable safe operation of large-scale, commercial UAS traffic.

The U.S. Federal Aviation Administration's self-stated continuing mission is “to provide the safest, most efficient aerospace system in the world.” There are many challenges to assurance of safe and efficient use of airspace, and key among the challenges is the incorporation of commercial BVLOS UAS traffic into airspace. Assurance of safe and efficient use of airspace by commercial BVLOS UASs is critical to the development of this transportation mode and will require more than just basic “detect and avoid” systems to ensure public safety and safe transit.

Reliance on “detect and avoid” systems to ensure safety in a corridor becomes more difficult as the amount of BVLOS traffic increases. Aspects of the present disclosure maintain a safe and efficient airspace via well-defined, managed UAS traffic corridors. Use of existing, well-defined infrastructure corridors, such as those of electric utilities, gas and oil pipeline owners and railroads to establish airspace corridors for UAS traffic facilitates a safe and efficient means of regulating commercial BVLOS UAS traffic.

In various embodiments of the present disclosure, and as part of operating an UAS traffic corridor, a navigation management system for each of the UASs may be implemented (or a networked navigation management system which processes navigational instructions for one or more UASs remote from the UASs). The navigation system enables the UAS to autonomously navigate from a first location to a second location, such as over long distances. The navigation system may perform path planning calculations to determine a route for the UAS to take in order to navigate to a desired destination. The path planning calculations may use data from pre-loaded maps and data acquired from sensors mounted on the UAS (and/or sensors within the corridor in proximity to the UAS) during flight in order to autonomously navigate the UAS. The navigation system may provide real-time navigational instructions to the UAS and/or provide a sequence of operational instructions.

The navigation system of the UAS navigates the UAS inside of corridors designated for operation of autonomous navigation of aerial vehicles. Such corridors are considered safe zones of operation for UASs for navigating between two locations. UAS corridors provide a clear airspace in which UASs can operate. The UAS corridors facilitate predicable, safe autonomous navigation of the UASs that does not interfere with other air traffic or infrastructure and in some embodiments may utilize traffic management for managing the plurality of UASs operating within the corridor. The UAS is configured to navigate using the UAS corridors such that the UAS does not enter unauthorized or forbidden airspace. The UAS is configured to navigate to a desired location by taking an efficient route, such as a route that has less congestion, limits market-based corridor fees, and/or the shortest route to the destination, etc. The navigation system can autonomously navigate the UAS along pathways designated to be within the UAS corridors. In some implementations, the navigation system plans routes along a pre-existing topological infrastructure. For example, the navigation system of the UAS can be configured to plan routes along electrical power grid infrastructure. Yet another example, the navigation system of the UAS may be configured to plan routes along telecommunication infrastructure, such as along data lines supported by utility poles. In some embodiments of a UAS system in accordance with the present disclosure, the navigation system of the UAS may leverage existing terrestrial infrastructure utilizing known topological layouts and identify elements of the topological layouts to further assist with navigation. Elements that are identified may include, but are not necessarily limited to, physical elements of the infrastructure; for example, a number of power line towers and their respective spacing/configuration, height of towers, shape of towers, etc. In yet further embodiments, the UAS may include a sensor suite which facilitates further confirmation of the infrastructure using, for example, multi-spectral signatures, e.g., visual, infrared, magnetic, LIDAR, RADAR, among others and as described in greater detail below.

Various aspects of the present disclosure are directed to guidance/tethering systems to facilitate computationally efficient routing of commercial drone traffic within a pre-defined corridor (e.g., power-line corridor). All electric power lines have both an electric field and a magnetic field associated with them when they are energized and carrying electric current. One or both fields may be detected by on-board sensors of a UAS (also referred to as an Unmanned Aircraft System or UAS) to navigate along the power-line corridor.

A magnetic field may be characterized by its space components along three orthogonal axes with respect to time. A resulting field magnitude can be calculated and compared to previous measurements to determine if a UAS is moving away from or parallel to the power line. The field magnitude is affected by electric current, distance from the conductors, and conductor orientation. For example, when using an X, Y, Z coordinate system the resultant field magnitude can be calculated by first measuring the magnetic field magnitude along each axis and then calculating the resulting field using the following equation: B=√(Bₓ²+B_{y}²+B_{z}²). The single-axis magnetic field intensity measurements can be made with existing measurement technology. The magnitude and direction of the field can be characterized by a vector which rotates through space around a single point, with the tip of the vector tracing an elliptical path. Although the field intensity does vary with time, the measurements can use the maximum field intensity at any one point which would be the major axis of the ellipse. The measurement may be stored in memory and used in a comparator circuit to compare with the future reading(s). In some embodiments, the comparator may use calculated field levels along a route or use boundary conditions or a derivative trend approach to determine if the route is still correct. These same methods may be used with limits or trends to control the movement of the UAS back towards the conductors when the computations show the UAS is moving towards a lower field strength which would indicate moving away from the conductors. Conductor arrangement may affect the resultant field shapes of the power lines and simple characteristics can be defined and used to map out a general “field shape” for both magnetic and electric fields that the UAS can use as a comparison tool. Varying transmission line conductor orientations from vertical position to horizontal position to delta position changes the effective field levels for an electric power line at one height, voltage, and loading. In some embodiments, the sag of the conductors, and the associated catenary “shape” of the field(s) may be accounted for with limits or pre-calculated levels or trends.

Details of the various embodiments of the present disclosure are described below with specific reference to the figures.

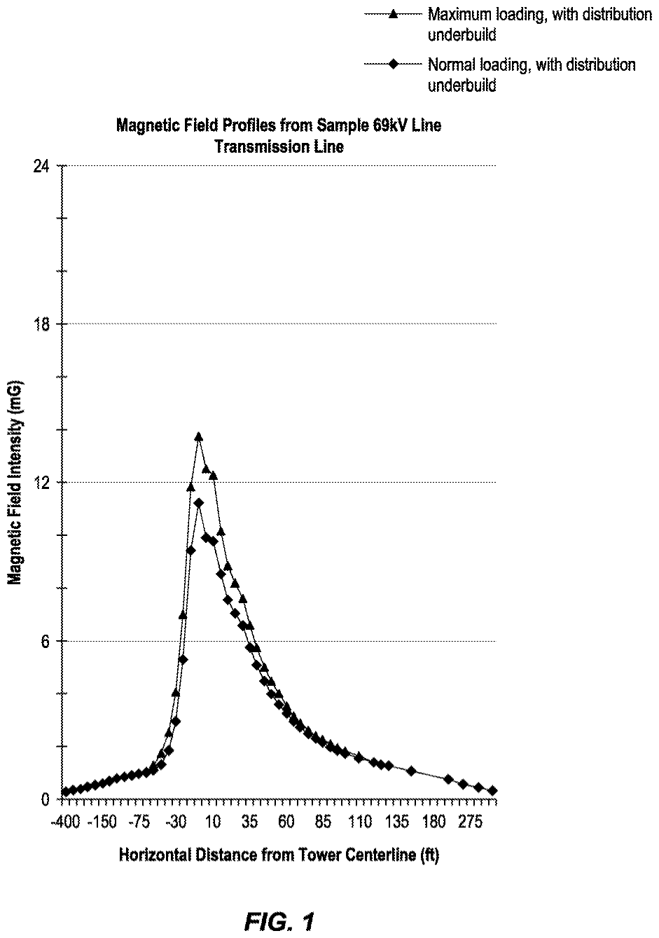

FIG. 1 is a graph illustrating a sample ground-level magnetic field intensity from a sample 69 kV electric transmission line expected to be carrying 112 Amps peak load. The graph showing ground-level magnetic field intensity as a function of horizontal distance from a tower's centerline (in feet). Curves for both maximum and normal loading of the transmission line are illustrated.

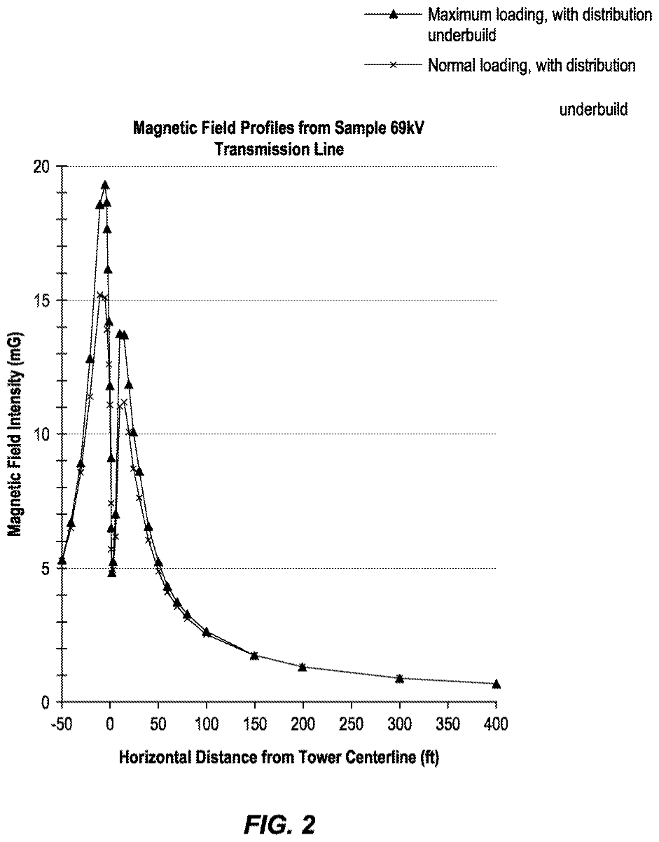

FIG. 2 is a graph illustrating a sample ground-level magnetic field intensity from a sample 69 kV electric transmission line carrying 181 Amps of peak load. The graph showing ground-level magnetic field intensity as a function of horizontal distance from a tower's centerline (in feet). Curves for both maximum and normal loading of the transmission line are illustrated.

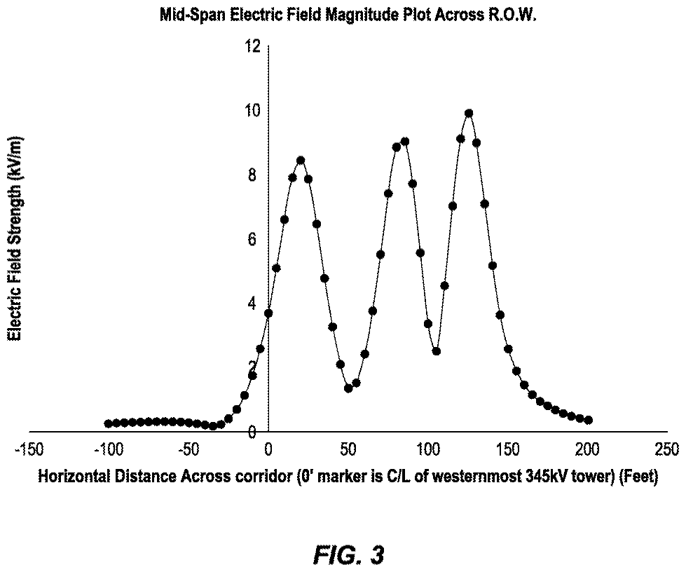

The electric field may be characterized by its space components along three orthogonal axes with respect to time. The strength of the field along each axis may be measured and the resultant field calculated using the same math described for magnetic fields. The field strength may be computed and compared to prior measurements to determine if the UAS is moving towards or away from the power line in the same manner as described for magnetic fields. The temporal characteristic of the electric field away from the power line conductors affects the resultant field strength magnitude very little, so the calculations may be made with efficient computations. The primary three factors affecting sensed field magnitude are voltage on the power line, conductor geometry, and sensing distance from the conductors. A sample, ground-level electric field strength map is illustrated in FIG. 3 for an electric transmission line corridor carrying three 345 kV circuits. FIG. 3 illustrates ground-level electric field intensity as a function of horizontal distance from the westernmost tower's centerline (in feet).

In various embodiments of the present disclosure a UAS may rely on one or both of magnetic field and electric field sensors to detect relative position to an electric power line. While magnetic field measurements are more readily ascertained given the state of magnetic field sensing technologies, magnetic field-based navigation requires electric power lines to be carrying current. When no electric current is flowing along the lines, in accordance with the world as described by Maxwell's equations no magnetic field is emitted from the lines and therefore navigation based on the magnetic field of the power line is prevented.

By simplifying the navigation-related processing demands, the power demand of the UAS on-board computer(s) may be reduced—which may facilitate longer flight times as more energy may be saved for travel rather than for guidance.

In various embodiments of the present disclosure, the UAS may use one or more of the following: camera, Global Positioning System, Real-time Kinematic (“RTK”), and pre-planned flight paths as back-up systems in case an electric power line in the travel corridor is de-energized or the current and/or voltage through the electric power line are too low for the magnetic fields to be used for UAS navigational purposes. For example, where the magnetic field emanating from the power line approaches background magnetic field levels. As another example, the back-up UAS navigation system may be utilized where the UAS is flying within an infrastructure corridor but at a distance from the electric power line that makes the field strength or intensity too low to be used for navigation. In yet further embodiments of the present disclosure, a navigational back-up system may be included. One such system may utilize a visual system, which at least partially relies upon visual aids, for example markings on the tops of power line towers, and/or other types of systems which utilize RTK systems in the power line corridors.

Another back-up navigation system may utilize power-line carrier signals on transmission lines that facilitate radio frequency signals to be used as a control mechanism to dis/allow UAS air travel a power line corridor. Data may be sent from substation to substation or from a predetermined point to another predetermined point along the power line(s) to provide command and/or control signals for UAS. For example, UAS air travel may be temporarily suspended when the corridor is unsafe for UAS operation—e.g., when work is being conducted in the corridor by line crews.

The natural magnetic fields of the earth are at or very near to a frequency of 0 Hz. The magnetic fields associated with most electric power lines are at the power line frequency (i.e., ˜60 Hz). Fields associated with communication systems or other guidance systems are at frequencies most often in the higher frequency ranges (i.e., kilo-Hertz or higher). Using band-pass or similar filters allows desired signals to be acquired and utilized). Various aspects of the present disclosure improve airspace management by (largely) confining commercial UAS traffic to infrastructure corridors. By utilizing existing infrastructure corridors for coordination of UAS traffic, UAS delivery and transport become increasingly feasible due to reduced safety constraints, and importantly, it better allows commercial UAS traffic to safely coexist with manned aircraft by reducing the Federal Aviation Administration's air traffic control burden through use of the dedicated UAS corridors.

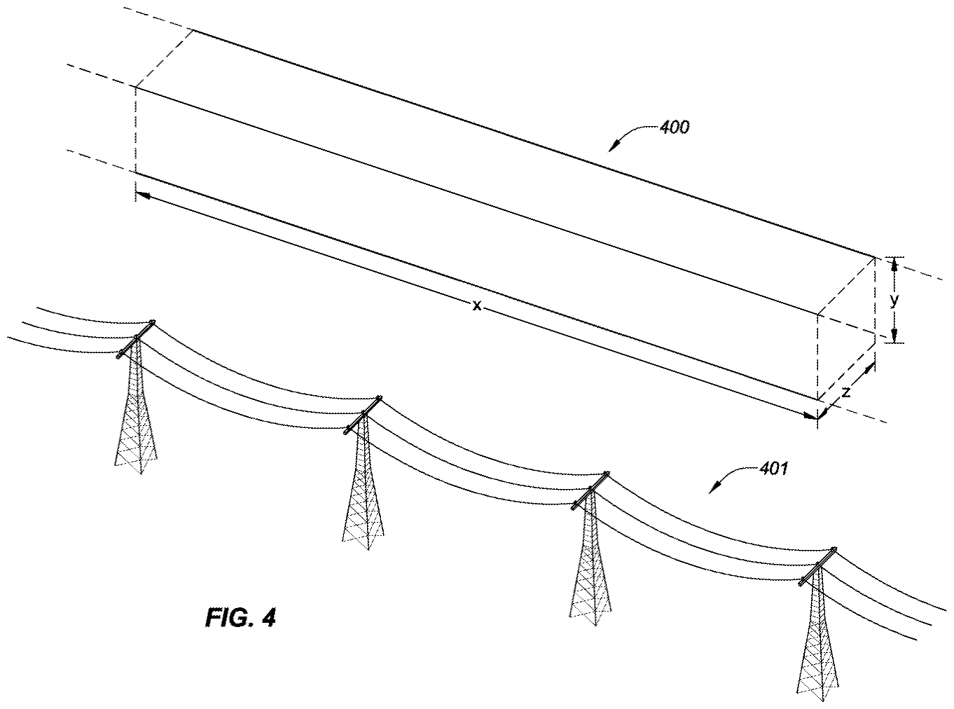

FIG. 4 is an illustrative example of a dedicated airspace 400 positioned overhead an infrastructure corridor 401, consistent with various embodiments of the present disclosure. Electric utilities, owners of gas and oil pipelines, railroad companies, telecommunication companies and other infrastructure companies operate their facilities in vast networks of individual or shared infrastructure corridors through which goods and services are conveyed to consumers. These infrastructure corridors 401 are present in most regions of the country, and the infrastructure may provide the land-based assets around which Unmanned Aerial System (“UAS”) traffic may be safely managed. Moreover, these corridors 401 may be readily modified or enhanced to facilitate necessary communication and/or control signals to individual UASs operating in the corridor. Communication may be accomplished via radio frequencies, or other means of mostly wireless communication. Communication to/from or even between the UASs provide needed checks and balances required for the safe operation of UAS, for example, beyond visual line of sight (“BVLOS”). Moreover, infrastructure corridors 401 may provide the backbone necessary for development of well-defined airspace corridors, and those well-defined airspaces can enable safe operation of UAS traffic (e.g., large-scale, commercial UAS traffic).

The FAA's self-stated continuing mission is “to provide the safest, most efficient aerospace system in the world.” There are many challenges to assurance of safe and efficient use of airspace, and key among the challenges is the incorporation of commercial UAV traffic into airspace. Assurance of safe and efficient use of airspace by commercial UAVs will be difficult, if not impossible, to achieve by sole reliance on individual UAV's “detect and avoid” systems to ensure public safety and safe transit.

Reliance on “detect and avoid” systems to ensure safety in a corridor becomes more difficult as the amount of traffic increases, especially in BVLOS applications. Aspects of the present disclosure maintain a safe and efficient airspace via well-defined, managed UAV traffic corridors.

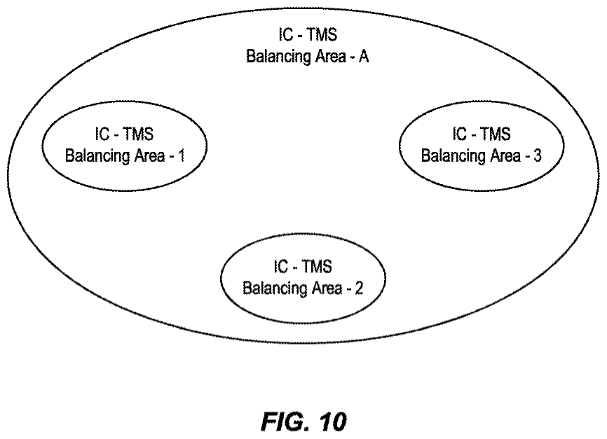

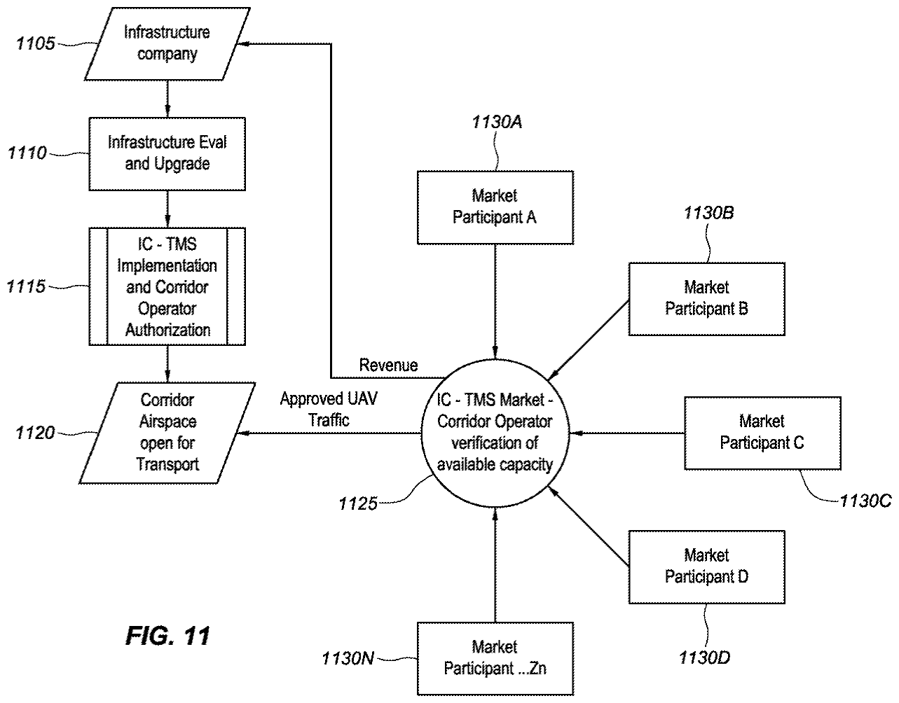

Various aspects of the present disclosure are directed to an Infrastructure Corridor UAS Traffic Management System (as discussed in more detail in relation to, for example, FIGS. 10 and 11). The Infrastructure Corridor UAS Traffic Management System (“IC-UMS” and also referred to in the figures as “IC-TMS”) may be developed as a sensing, communication and control overlay for Infrastructure corridors. Each IC-UMS may be customized for a given corridor, where the land-based assets may be augmented with necessary facilities and equipment to enable use of the IC-UMS. The IC-UMS may allow commercial UAS traffic to utilize well-defined, FAA approved airspace above or near participating infrastructure companies' facilities in the corridor. Those infrastructure facilities may include electric utility lines, gas and oil pipelines, railroad tracks, streetlight networks, and telephone networks, among other infrastructure. Each IC-UMS may be developed based on evaluation of the unique characteristics of each infrastructure corridor. Upon completion of the evaluation, the necessary sensing, computing, communication and control equipment may be added to/installed on and/or around the infrastructure to enable the IC-UMS. The IC-UMS may, through active management of a Corridor Operator, monitor and control BVLOS UAS traffic in the corridor and corridor access.

The infrastructure corridors may consist of, for example, individual airspace corridors including segments of 3-dimensional, well-defined volumes of airspace within, near, or above the infrastructure itself. The operation of commercial BVLOS UASs utilizing the infrastructure corridor airspace may rely upon and be managed by a Corridor Operator, where the authority of the Corridor Operator may be subject to FAA requirements and FAA authority. The role of the Corridor Operator may be to serve as the entity responsible for management of BVLOS UAS traffic within the infrastructure corridors airspaces. The Corridor Operator's ability to maintain safe and efficient BVLOS UAS traffic will be influenced by several factors, and key among those factors is continual operation within a defined safe operating limit.

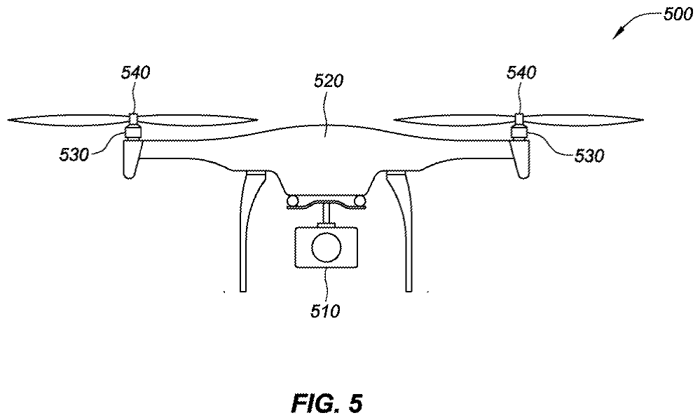

FIG. 5 illustrates an example UAS 500 with a navigation system, consistent with various embodiments of the present disclosure. The UAS 500 may include a frame 520 to which one or more lift inducing elements (or propulsion units) are coupled. In the present embodiment, the one or more lift inducing elements includes a motor 530 coupled to one or more propellers 540.

The UAS 500 includes a navigation system 510 which is configured to autonomously navigate the UAS along designated UAS corridors. The navigation system 510 includes a sensor package for collecting data about the local environment. The collected data is used for path selection and navigation and may be further communicated with a Corridor Operator where approval or selection of a flight path originates externally. In various embodiments of the present disclosure, a primary navigation mode may rely upon magnetic field sensing associated with an electric power line within the UAS corridor. However, one or more other types of sensing techniques may be employed by the navigation system (as a primary or secondary system); for example, passive optical, thermal, RADAR, LIDAR, etc. The navigation system 510 may include one or more processors configured to process both environmental data received from the sensor package of the UAS 500, data stored in a storage of the UAS, as well as Corridor Operator instructions.

The navigation system of the UAS 500 is configured to gather data about an environment of the UAS 500. The data gathered can be used for the navigation system 510 to determine the location of the UAS in an infrastructure corridor and for the navigation system 510 to plan a path for the UAS through the corridor. For example, the navigation system 510 can be configured to recognize a navigation landmark for localization, as described in further detail below. The navigation system 510 may be specialized for the environment being navigated, such as to interact with a particular infrastructure or feature of the corridor during navigation, as described in further detail below. In some implementations, the navigation system 510 includes many discrete sensors in the sensor package. For example, the sensor package of the navigation system 110 may include a magnetic field sensor, an electric field sensor, global positioning system (GPS) receiver, an infrared (IR) sensor, a thermal sensor, radar, an electro-optical sensor, an auditory sensor, an accelerometer, a compass, a ranging sensor, a camera, or other such sensors for gathering environmental data related to the corridor and other UASs operating therein.

While the navigation system 510 is depicted as being positioned outside of the UAS 500, in some implementations, the navigation system may be positioned inside a housing of the UAS 500. In some implementations, one or more of the sensors included in the navigation system 510 may be positioned inside of the housing of the UAS 500 and one or more of the sensors may be positioned outside of the housing of the UAS 500, e.g., depending on the design and/or function of the sensor.

In various embodiments of the present disclosure, the navigation system 510 is configured to autonomously navigate the UAS 500 through one or more corridors using features of those environment as detected by the one or more sensors and interpreted by the navigation system 510. The sensors of the navigation system 510 can be configured to navigate the UAS 500 along routes designated by a preexisting infrastructure that defines the corridor, or along routes as instructed by a Corridor Operator under an IC-UMS.

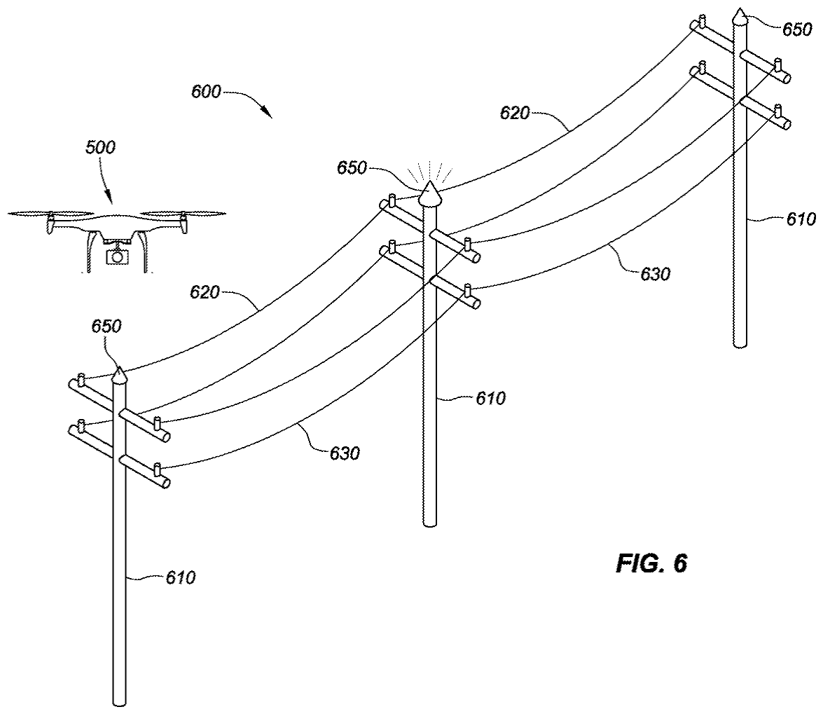

FIG. 6 illustrates a UAS 500 operating within a corridor 600, consistent with various embodiments of the present disclosure. The corridor 600 includes power transmission and distribution infrastructure and/or telecommunications transmission infrastructure. Utility poles 610 that support electric power lines 620 define the permissible airspace of the corridor 600. The utility poles 610 and electric power lines 620 together form a network that includes features that are detectable by the navigation system 610 of the UAS 500 and that are used during autonomous navigation. While corridor 600 shows electric power line infrastructure, other infrastructure networks, in which UASs can localize themselves relative to the infrastructure, can establish a corridor. For example, a corridor could be established using a road network, pipeline network, canal or waterway network, train tracks, etc. In some implementations, cell tower networks can be used, such as using transmitted tower identification data, signal strength, etc.

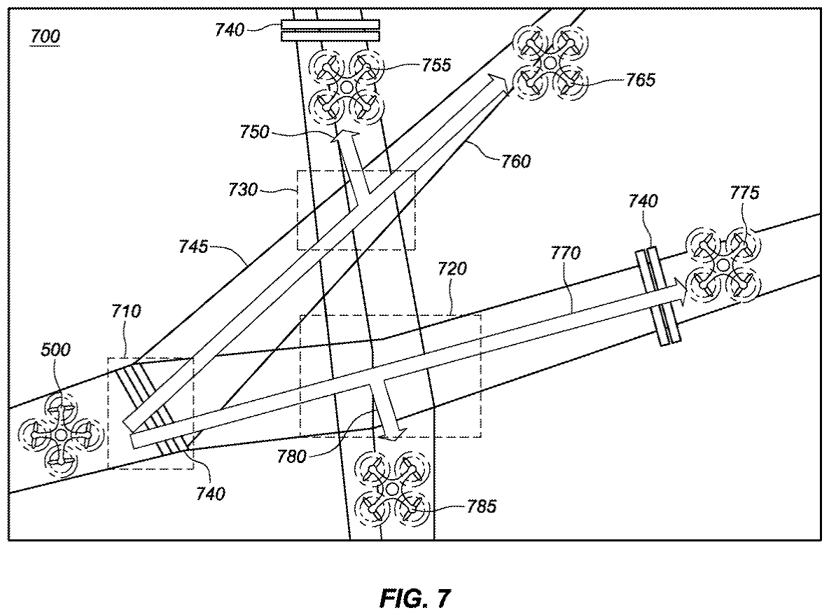

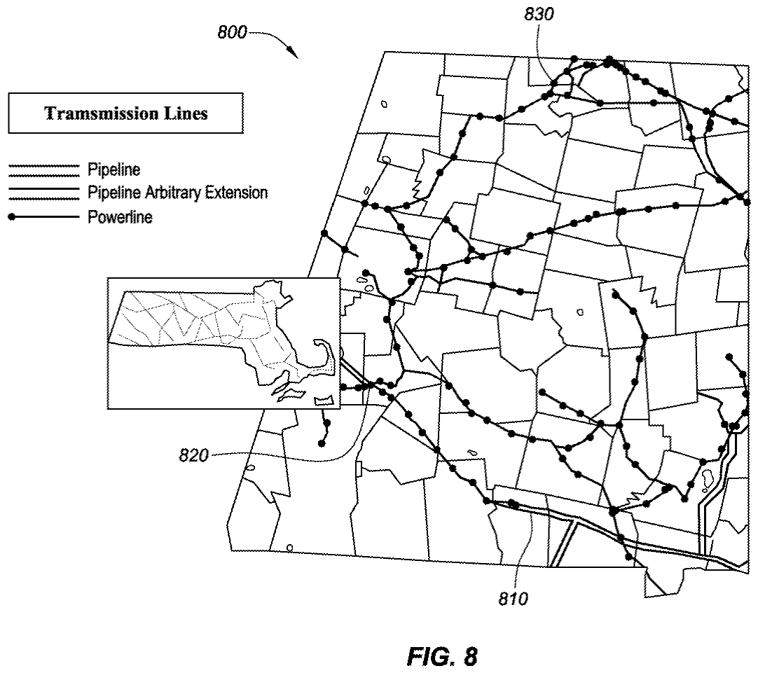

The navigation system 510 of the UAS 500 may determine a route along the corridor 600 that brings the UAS closer to a desired destination. In some implementations, a route can be planned according to data from a preloaded map of the electric power infrastructure, or from instructions communicated by a Corridor Operator in an IC-UMS. For example, the navigation system 510 may localize the UAS 500 to a position in the network of transmission infrastructure and plan a path through the transmission infrastructure to the desired destination. In some implementations, the navigation system 510 does not have a preloaded map for path planning along an infrastructure of corridors 600, but instead navigates towards a destination (e.g., designated by a known GPS coordinate) by anticipating a route as the UAS 500 navigates along the infrastructure. Navigation techniques are described in further detail in relation to FIGS. 7 and 8, below.

In some embodiments of the present disclosure, the navigation system 510 of the UAS 500 may sense the corridor 600, such as in the FIG. 6 the utility poles 610 and/or electric power lines 620, and navigates the UAS along the corridor. The following examples can be used either individually or in any combination during navigation for sensing and navigating the UAS 500 to a desired destination via a network of corridors 600.

In some implementations, navigation system 510 of a UAS 500 may include a camera, the data from which may be processed by the navigation system to localize the UAS within a network of corridors using known visual features of the environment. For example, the utility poles 610 may be recognized by the navigation system 500, and in turn the navigation system plots a parallel course to ensure that the UAS does not stray too far from the electric power lines by observing the relative locations of nearby utility poles. In some implementations, the navigation system 510 is configured to visually recognize towers used in high power transmission lines, which may have a distinct visual signature relative to other features of the surrounding environment. For example, a tower may include a number identifying the particular tower (e.g., an attached label presenting the numerical identifier). The navigation system 510 may utilize computer vision techniques to identify the number and determine the location of the UAS 500 based upon a stored map that associates the identified tower with a location in space.

The navigation system 510 may also identify lines (e.g., power lines 620) that span between the poles 610. For example, image processing algorithms may be used to detect a visual signature produced by one or more lines 620. Such image processing may be supplemental, or a back-up system, to navigation based-upon a magnetic field 630 emanating from the power lines 620. The navigation system 510, upon detection of the power lines, may associate the power lines with an infrastructure corridor 600, and course-correct (if necessary) to follow the one or more lines. In some implementations, the navigation system 510 may localize the UAS 500 based on a size or number of detected lines 620.

In some implementations of the present disclosure, the navigation system 510 includes a magnetic sensor configured to measure magnetic fields 630 generated by power transmission along lines 620. For example, the magnetic sensor detects a direction of the magnetic field 630 proximate the lines 620. Since the magnetic field generated by power transmission is proportional to the amount of current flowing through the line 620, the navigation system 510 may determine a distance from the magnetic sensor to the lines 620 (in accordance with the discussion above). The navigation system 510 detects both a magnitude and direction of a local magnetic field. The navigation system 510 can determine the orientation of the UAV 500 relative to the lines 620 using the measured direction of the magnetic field. The navigation system 510 may store magnetic field measurements and detect changes in the detected magnetic field over time. The magnetic sensor may detect magnetic fields of magnitudes that are less than 100 mG, such as those produced by 345 kV power lines. In some implementations, the magnetic sensor may be sensitive enough to detect magnetic fields as small in magnitude as 0.1 mG.

In various embodiments of the present disclosure, a navigation system 510 of a UAS 500 uses the measured magnetic fields to determine a location of the UAS 500 in space and a direction of travel relative to the transmission lines. For example, the navigation system 510 may determine whether the UAS 500 is straying from a transmission line 620 if a sensed magnetic field falls below a certain threshold. In such a case, the navigation system 510 may course-correct the UAS 500 to navigate closer to the transmission lines 620. With some knowledge of the network infrastructure, the UAS may also confirm or determine a position based upon changes in a sensed magnetic field 630 along a power line corridor 600. For example, in response to the UAS 500 approaching higher-current power lines or a power substation, a magnetic field sensor may sense a sudden spike or other deviation, which the navigation system 510 may use to determine that the UAS 500 is at or near a position on the corridor 600 that includes a step up to higher voltage power transmission. The navigation system 510 can thus narrow a list of possible locations in which the UAS 500 is located, such as in reference to a stored map of transmission infrastructure. Such localization may also assist in path planning, as described in further detail below.

In some implementations, a beacon 650 on a utility pole 610 can be used to assist in navigation, such as in embodiments where the primary navigation input is from a magnetic field sensor. The beacon can be a visual beacon, an infrared beacon, an electromagnetic beacon, a data transceiver, etc. that transmits a signal that is recognizable to the navigation system 510 of the UAS 500. Beacons 650 may be used to identify a corridor 600 itself, an intersection within the corridor, a location within the corridor, or otherwise communicate information necessary for safe operation of a UAS within the corridor. In some implementations, the beacons 650 are uniform or mostly uniform. In some implementations, one or more beacons 650 can be located in the environment at particular locations that are used for navigation, localization, and/or path planning by a navigation system 510 of one or more UASs. For example, a utility pole 610 may have a particular beacon at a junction between two different corridors. The beacon may indicate to the navigation system 510 (via a beacon detector) that the UAS 500 is at the corridor junction, such as by being a specific color, transmitting a data signal on a predetermined channel, flashing at a particular frequency, or various other communication methodologies. In some implementations, the beacon 650 is used for traffic control, such as to indicate that a route is congested, blocked, etc. A location of the beacon 650 within a corridor 600 can be indicated on a preloaded map of a UAS navigation system 510. While various embodiments of the present disclosure, such as FIG. 6, present the beacon 650 atop a utility pole 650 in corridor 600, a beacon may be placed in various locations throughout the corridor, such as on other infrastructure within the corridor or on the ground below the corridor. In some implementations, the beacon 650 is installed on a part of the infrastructure within the corridor, such as a street light, train signal, etc.

In some embodiments of the present disclosure, a UAS 500 may have a navigation system 510 that is capable of being communicatively coupled to a Global Positioning System (“GPS”) for localization and navigation of the UAS. This GPS location may be a back-up navigation system to magnetic-field based navigation, or complimentary thereto. The navigation system 510 can correlate GPS data gathered to a preloaded map to determine the position of the UAS 500 on the map. The navigation system 510 uses GPS data to determine the heading required for travel to reach the desired destination and can plan a route along one or more infrastructure corridors 600. Upon determining a start position of the UAS and a route plan to the destination using known infrastructure corridors (e.g., power-line corridors), the GPS may be powered down and primary navigation along the power-line transmission corridors may be based upon magnetic-field signals received from the power-lines running along the corridor.

In various specific embodiments of the present disclosure, a navigation system 510 of a UAS 500 gathers data from multiple sources (e.g., GPS, thermal, electromagnetic, infrared, visual, etc.) as described above for redundancy and to increase the accuracy of localization (where necessary). For example, where the UAS is travelling along a power-line corridor that is not transmitting energy, no magnetic field is produced, and other position indicative data must be relied-upon by the navigation system 510 for navigation and localization.

FIG. 7 illustrates an example of an UAS 500 navigating a network of corridors 700, consistent with various embodiments of the present disclosure. The environment of corridors 700 includes junctions 710, 720, and 730. In the example embodiment of FIG. 3, the UAS corridors 700 run along (or above) a transmission line infrastructure, but use of other infrastructure, such as railroad lines, roads, pipelines, etc. are readily envisioned.

A navigation system of the UAS 500 may plan a path and navigate to a target destination in several stages. The UAS 500 gathers data about the network of corridors 700 using various on-board sensors (e.g., magnetic field sensors, GPS sensors, visions systems, etc.) and pre-loaded information (e.g., maps of the infrastructure network). After acquiring environmental data from the various on-board sensors, the UAS may determine its position in the network of corridors 700, and plot a path from the determined position to a target destination, taking into account corridor constraints. The constraints may be detected by the on-board sensors and/or information stored with a memory unit of the UAS. Once a path has been acquired by the UAS (or pushed to the UAS via a networked navigation systems) along the corridor network to the target destination, the UAS determines a first target heading along the planned path which takes into account any impediments to flight (e.g., other UASs).

Gathering data about a present UAS location using one or more (redundant) sensing systems may facilitate improved localization and navigation of the UAS 500 in a network of corridors 700. The UAS 500 may build a local map of its surroundings and compare the local map to a preloaded global map. Generating the local map increases navigational accuracy; for example, correcting for GPS inaccuracies. The local map may be used for navigation if a primary navigation input is disrupted. For example, when a UAS 500 arrives at junction 710 while navigating through the corridor network, the UAS gathers data about the junction to identify it as being junction 710 (via one or more sensing systems communicatively coupled to a navigation system). Based on a preloaded global map, the navigation system of the UAS understands that there should be two diverging sets of power lines at junction 710. By detecting the diverging sets of power lines 745 near junction 710, the UASs position at junction 710 may be confirmed. To further ascertain (or confirm) the position of the UAS 500, one or more sensors may be utilized to determine a type of tower 740, detect a tower number displayed on the tower, and/or detect a wireless signal emitted from a beacon on or near the tower. Based on the totality of the sensor input signals received, the navigation system will be able to determine, based on the totality of the gathered data, if the UAS is near junction 710.

Where the UAS 500 is unable to positively identify junction 710 (and thereby localize its relative position thereto), the UAS may continue to navigate along the corridor until it reaches junction 730, for example. At junction 730, the UAS 500 gathers additional data. At junction 730, the followed transmission lines cross another corridor defined by three parallel power lines. Based on data gathered at a combination of junctions 710 and 730, and data collected between the two junctions, the collected data may be correlated with a portion of the preloaded map.

In some implementations, rather than using landmarks, the navigation system 510 builds a map from scratch during navigation. The map is built using the environmental data gathered by the one or more sensors of the UAS 500. In some implementations, the UAS uploads the map to a Corridor Operator (via an onboard transceiver) that may share the sensed information with other UASs entering the corridor or network of corridors. In this way, a plurality of UASs may work together to build and update a map of the Corridor 700. In such a way, computing power required for navigating later flights through the corridor or network of corridors is minimized. For example, if a portion of the Corridor changes or becomes unusable (e.g., if a power line is no longer transmitting electricity, the line is no longer detectable by a UAS 100 utilizing magnetic-field sensing as a primary mode of navigation), the UAS may communicate this to a Corridor Operator. The Corridor Operator may then push notifications to other UASs regarding that corridor and (recommend) re-routes for UASs also utilizing magnetic-field sensing as a primary mode of navigation.

Once UAS 500 has determined its position, the UAS plans a path (or receives instructions from a networked navigation system remotely located from the UAS with operational instructions). For example, the UAS may determine that a target destination is in a direction of route 760. By recognizing features of the route 760, such as that the route has two parallel power lines, UAS 500 can choose route 760 to navigate to position 765. In another example, the UAS 500 may plan a path along route 750. By recognizing the tower 740 is near junction 730, and that route 750 includes three parallel power lines, UAS 500 navigates to position 755. The UAS 500 may utilize the on-board magnetic field sensors to detect the number of power lines along a direction of travel and to further identify power line junctions (including the number of intersecting lines). To further confirm a junction or position of a tower, for example, the UAS may utilize secondary sensing systems such as a vision system to detect identifying information about the tower. UAS 500 may use a similar approach to distinguish junction 720 from junction 710 and junction 730, and to navigate along route 780 to position 785 or along route 770 to position 775. In various embodiments of the present disclosure, the UAS mitigates power-usage associated with navigation and localization by reducing usage of the various/particular sensors.

While in various embodiments of the present disclosure a Corridor Operator may control certain aspects of a UAS's flight through a corridor or network of corridors (by transmitting instructions to a transceiver of the UAS), the UAS 500 may deviate from a provided flight plan, at least to some degree. For example, the UAS must take into account obstacles in its immediate surroundings (e.g., buildings, trees, other UASs, power lines, etc.). In one example implementation of object avoidance in accordance with the present disclosure, if the UAS detects an obstacle in its immediate flight path, the UAS may implement one or more maneuvers to safely navigate around the obstacle before reverting to the pre-arranged flight path.

In some more specific embodiments of the present disclosure, two or more UASs 500 may coordinate with one another for path planning, navigation and localization in an effort to reduce power draw associated with such systems and related sensors. The UASs 500 may communicate with one another in a communications network directly between UASs or via an intermediary (e.g., a Corridor Operator). Where data from the various UASs within a corridor or network of corridors is received centrally by a Corridor Operator, the majority of navigation related computing power for each of the UASs may be centralized and simple flights path corrections may be communicated to the UASs for execution.

In yet further embodiments, UASs may share processing power with one another. For example, a first UAS may offload some of its processing calculations to a second UAS if its power supply is low (e.g., fuel is below a predefined threshold, a battery is below a predefined charge, etc.). The second UAS accepting the additional processing calculations may have more power than the first UAS and thereby communicate to other UASs that it is capable of performing additional processing for other UASs.

FIG. 8 illustrates an example of a mapped networked infrastructure corridor 800, consistent with various embodiments of the present disclosure. The mapped networked infrastructure corridor 800 may include one or more features that are useful for navigation/localization of UASs within the network. In some implementations, the map is a preloaded map. For example, when a UAS is navigating along a power line corridor and detects a transition to a pipeline corridor, the UAS may determine that it is at one or more locations (e.g., locations 810 or 820). The UAS may compare known data about the networked infrastructure corridor 800, such as the power level of transmission lines at various locations, to data gathered by on-board sensors of the UAS. The networked infrastructure corridor map may include meta-data such as the power level of transmission lines at various locations throughout the networked infrastructure corridor.

In some implementations, the mapped networked infrastructure corridor 800 may be modified by the UAS to store newly acquired information about the infrastructure corridor being navigated. For example, the UAS can perform power line inspections while using the grid routes as flight corridors. Instantaneously or at a later time, the newly acquired information about a state of the infrastructure corridor may be transmitted to an entity tasked with maintaining the portion of infrastructure associated with the UASs location at the time of detection (e.g., to report the need for maintenance, etc.). In some specific embodiments of the present disclosure, a master of the mapped networked infrastructure corridor 800 may be stored by a Corridor Operator and updates to map may be pushed to UASs operating within the corridor in real-time, on a regular basis (e.g., daily), or upon entering the corridor network. As described above, the map 800 may be updated by different UASs navigate the network of corridors. In response to a UAS detecting an anomalous state with respect to a known condition of a corridor at a given location, the UAS may communicate the anomalous state to the Corridor Operator. The UAS may, for example, indicate the anomalous state with respect to location, via a geotag for example, and/or with respect to time, via a timestamp for example. The anomalous state may then be appended to the mapped networked infrastructure corridor 800 and disseminated to the other UASs within the networked corridor—facilitating the use of such information by other UASs for path planning, localization, etc.

### Infrastructure Corridor UAS Management System

An infrastructure corridor and junction UAS management system (“IC-UMS”), consistent with various embodiments of the present disclosure, may operate based on the determination of the safe operating limit of UAS traffic within each segment of an Infrastructure corridor's airspace. The maximum safe operating limit will be based upon unique attributes of infrastructure corridor's airspace and the conditions therein. The safe operating limits may not be static and may vary depending on the orientation of the corridor and direction of travel of the UAS within the corridor. Moreover, the corridor's safe operating limits may vary with respect to, among other things, physical characteristics of the corridor, weather, individual UAS physical characteristics, UAS performance characteristics and UAS density/demand within the defined volume of infrastructure corridor airspace.

In a basic implementation, an infrastructure corridor airspace may be managed by an IC-UMS by limiting corridor use to a single type (or class) of UAS; however, use of a single type of UAS may be undesirable as needs will vary greatly, and use of a single UAS type may unnecessarily limit airspace corridor throughput. To accommodate the use of multiple types of UASs, the Corridor Operator may approve the use of the corridor to multiple UAS types simultaneously. The “approved” UAS types may have various performance and payload characteristics which increase the flexibility and utilization of the airspace. Moreover, allowing the Corridor Operator to approve UAS types may help reduce adverse impacts to the public by verifying UASs adhere to requirements and standards such as noise limitations, safety standards, and performance characteristics including minimum range, flight plan variance, and others.

For an IC-UMS to operate an airspace corridor within its non-static, safe operating limit, forward-looking ratings may be desirable. Forward-looking corridor ratings may be determined through use of Base Ratings and Conditional Modifiers. Base Facilities Ratings are derived from several parameters used to determine an “ideal rating” for nominal conditions. Base ratings may be derived from the below items and other relevant criteria: Physically Defined Volume of Air Space—Inclusive of required clearances; Communication Limiters—This can be bulk, fleet or individual communication limits that collectively form a communication limit for a corridor; Computational Limiters—This can be a bulk, fleet, or individual limits that collectively form a compute limit to the corridor; Externality Limiters—This can include limits based on total audible noise, local regulatory restrictions, etc.

The safe operating limit, or rated capability of a corridor or junction, may be determined from considering each of the Base Ratings individually, or considering each of these attributes in total and setting the rating based on the most limiting element thus delivering a capacity limit for throughput with respect to safety. This could be based on the attributes of a standard UAS to directly relate to the capability of a facility. For example, a corridor under a certain set of standard conditions might be able to have twenty standard UAS safely operating in the corridor, simultaneously at a given speed, but only have five standard UAS operating in that corridor. This means that the corridor is operating at 25% of its available rating.

Conditional Modifiers represent conditions that impact ratings and dynamically adjust the base rating for corridors. These conditional modifiers may be planned for in advance or adjusted in real-time with emerging conditions. Some examples of Conditional Modifiers include: Weather Conditions—Temperature, Wind, Precipitation, etc.; Equipment Conditions—Status, Loading, etc.; Capacity Factor—Based on physical and performance attributes of UASs in the corridor with respect to applicable corridor capabilities (e.g., Maximum Capacity Factor of X-type UAVs capable of transporting 5 lbs. versus Capacity Factor of Y-type UAVs capable of transporting 50 lbs. and the maximum Capacity Factor of various combinations of X-type, Y-type and n-Type UASs under given Corridor capabilities.); and Externality Limiters—Planned underlying infrastructure maintenance, corridor disruptions due to planned events. For some conditional modifiers, the direction of travel may result in different impacts to ratings based on direction of UASs' travel in particular multi-directional corridors.

Emergency Conditional Modifiers are represented by conditions that impact ratings (negatively or positively). Examples of Emergency Conditional Modifiers include: Short Term Environmental Conditions—Storms, Lightning, Tornados, Hurricanes, Blizzards, etc.; Major Compute or Communication Limits—e.g. failure of necessary IC-UMS component (communication link, telemetry, etc.; Security (National/Local)—e.g., Cyber Threats; and Externalities (Applies for defined UAS Corridors)—Unplanned underlying infrastructure disruptions, unplanned emergence of physical barriers to safe UAS travel—e.g. local law enforcement conditions

The Base Corridor or Facility capacity may be modified by the Normal Conditional Modifiers to develop dynamic ratings for corridor airspaces. These ratings will typically vary throughout the year. Extreme/Emergency Conditional modifiers may be applied at any time. Extreme/Emergency Conditional modifiers are likely to be sudden and of high magnitude and may impact market operations of the corridors as scheduled traffic may be substantially disrupted with abrupt increases or decreases to the ratings.

The role of determining non-static ratings by the Corridor Operator may require separation of the Corridor Operator (or the entity that determines corridor ratings) from market influencing functions. Market power could potentially be exerted by a Corridor Operator who also has financial interest in corridor throughput, where the Corridor Operator can be advantaged through corridor ratings and benefits from the change in throughput of the airspace corridors. A regulatory structure may be needed to ensure that market power is not exerted by any party.

The Corridor Operator will serve to actively manage, via the IC-UMS, UAS traffic into, out of and within the infrastructure corridor airspace to ensure operation within the established safe operating limit (this may include coordination with the FAA, where necessary). The IC-UMS may require knowledge of the location and the unique identity of each UAS within the corridor; this may be accomplished through Global Position System, RPK, or other means of geolocation and telemetry and/or through radio frequency identification tagging, visual coding or other means of unique identification of UASs. The various sensors comprising the sensor suite that facilitates navigation of the UASs within the corridor may include sensors which are positioned on one or more of the UASs, on corridor infrastructure, etc.

The operation of UASs within the airspace corridor may be accomplished through iterative IC-UMS evaluation of efficient use of the airspace corridor capacity based on the evaluation of available capacity with respect to safety limits and/or corridor ratings. Requests for use of the airspace corridor may be processed by the IC-UMS based upon an evaluation of accumulated point of entry and point of delivery requests, where entities desiring utilization of the airspace corridor for delivery may request entrance into a specific corridor “gate” and exit from the airspace corridor at an approved corridor gate. Requests for multi-stop deliveries may be processed as a series of entry and exit requests. Under one scenario, transit of the UAS through the corridor may occur via flight-plans that are communicated to the UAS (from the IC-UMS) via secure communication at a gate at which a UAS is to either enter (or exit) the infrastructure airspace corridor. Pushing the flight plan to the UAS at a gate may be necessary for emergency operations or changes in flight plans due to planned or unplanned system disturbances. Each UAS, through its unique identifier, may be uploaded flight plans providing information, including but not limited to elevation, speed, directional information and entry and exit designated times/points. Verification of UAS conformance with flightpath may be provided via necessary telemetry from the infrastructure corridor's monitoring equipment.

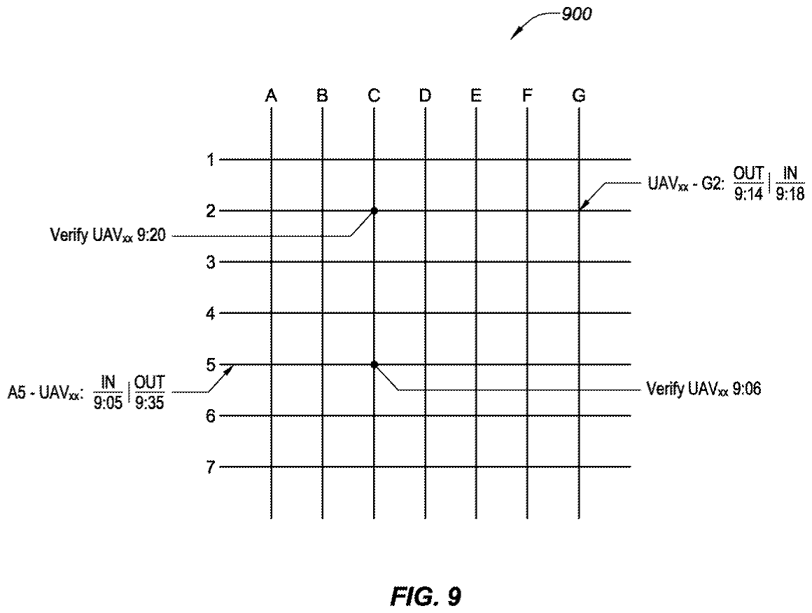

FIG. 9 is an illustrative example of an IC-UMS 900, consistent with various embodiments of the present disclosure. More specifically, FIG. 9 is an overhead graphic illustrating a single-layer flightpath grid to coordinate safe UAS traffic in a 3-dimensional volume of airspace above an infrastructure corridor. In various embodiments of the present disclosure, each volume of airspace may consist of multiple layers of flightpath grid layers, and individual flightpath grid layers may be further separated by no-fly layers where deemed necessary for safe UAS traffic throughput. Flightpath grid layers may represent flight paths at a particular elevation, particular distance above ground level or other airspace coordinates defined for UAS traffic. Moreover, in some embodiments necessary separation of flightpath grid layers within a volume of airspace correlate to the minimum vertical separation requirements from manned aircraft (e.g., where manned aircraft flight paths overlap with UAS flightpaths). Flightpath grid layer separation for UAS traffic may also be contingent upon, among other things, individual corridors' physical properties, weather, individual UAS physical characteristics and UAS performance characteristics.

FIG. 9 illustrates a “there and back” routing of a single, UAS on an individual flightpath layer 900 of an infrastructure airspace corridor. In the illustrative example, the UAS is scheduled into the airspace corridor at a specific entry “gate” which is represented on the example grid at point A-5. In the example case, the UAS is to enter at a prearranged time of 9:05 and is scheduled to exit via the same A-5 gate at 9:35. The UAS's flight through the corridor is verified at point C5 at 9:06 on its way to the point it exits the infrastructure airspace corridor at gate G-2 at 9:14 for a delivery to a point outside the infrastructure airspace corridor. The UAS completes its delivery and reenters the corridor at gate G2 at 9:18, and the UASs return travel is verified at waypoint C-2 at 9:20 on its way to exit the corridor at the same gate it entered through, gate A2, at 9:35.

In various embodiments of the present disclosure, consistent with FIG. 9, the flightpath layer or grid 900 of FIG. 9 may be a top layer (or any layer for that matter) of a 3-D stack of altitude layered flightpath grids.

### Airspace Corridor/Land Corridor Hybrid IC-UMS

The IC-UMS ability to provide safe and efficient airspace use above or near infrastructure corridors will bring efficiencies to the operation of commercial UASs. Additional benefit maybe realized through optimization of airspace corridor resources and land-based transportation resources. This may be especially true for non-adjacent or non-contiguous infrastructure systems. Incorporating land-based transport by, under one scenario, land-based bulk transport of UASs, into the IC-UMS managed system can enable efficiencies across transportation modalities. The ability of the IC-UMS to optimize transport across modes of transportation will enable infrastructure corridors to be utilized to a greater extent than through use of a single infrastructure corridor airspace alone.

Optimizing across modes of transportation will also allow for quicker implementation of larger or more complicated airspace corridor networks. This will allow infrastructure airspace corridor networks to be developed through planned practical phases of expansion, and it will also allow for optimization of delivery resources.

### Balancing Authority TMS

FIG. 10 is an illustrative example of an infrastructure corridor UAS traffic management system with balancing areas, consistent with various embodiments of the present disclosure. Infrastructure corridors or other similarly functioning UAS traffic airspaces may not be developed as a single effort to produce an all-encompassing, singularly managed system. Managed UAS airspace systems may develop as individual networks, and those networks, whether they be connected via adjacent airspace or via use of land-based resources may intersect/cross other infrastructure corridors. Accordingly, aspects of the present disclosure are directed to an UMS that provides a Corridor Operator or other manager of UAS traffic with a Balancing Authority Traffic Management System (“BA-UMS”).

As a balancing authority, a corridor operator, like those associated with an IC-UMS, may have the ability, through acquired telemetry, to provide accounting of UASs entrance to exit from each corridor. Accounting of UAS traffic into and out of the balancing area is necessary for coordination of UAS traffic across the seams of individually managed systems/corridors. Parallel, first tier BA-UMS (e.g., IC-UMS Balancing Area A) may coordinate traffic across the seams of their balancing areas via coordination through one or more second tier BA-UMS (e.g., IC-UMS Balancing Areas 1-3), which may account for traffic across multiple, individually managed UAS traffic areas. These second tier balancing authorities may serve as a system operator that interacts with Corridor Operators of individual, 1^{st} tier balancing authorities. The concept and process of layering tiered balancing areas and their BA-UMS may be extended to larger, more regional balancing areas to the extent practical. The establishment of each higher tier balancing authority will further facilitate traffic optimization at the seams of the first and second order balancing areas and to reduce adverse impacts from one balancing authority to another.

### Market-Based IC-UMS

FIG. 11 is an illustrative example of a market-based infrastructure corridor UAS management system 1100, consistent with various embodiments of the present disclosure. As shown in FIG. 11, a market for commercial UAS along infrastructure corridor airspaces may rely upon a number of components, including for example: an infrastructure company 1105; a Corridor Operator 1125 to regulate UAS traffic in an infrastructure corridor airspace above the infrastructure corridor (in some embodiments, the corridor operator 1125 may further require/have regulatory authority under, for example, U.S. Federal Aviation Administration to operate a UAS infrastructure corridor airspace); and 3) an IC-UMS market entity that serves as a clearing house for Market Participants' procurement and reservation of UAS corridor capacity.

The infrastructure company 1105 may first conduct an infrastructure evaluation and upgrade analysis 1110 of the infrastructure corridor to determine the necessary communication, computing, and UAS charging capabilities needed to convert the existing infrastructure corridor, and to enable UAS traffic along airspace above the infrastructure corridor. Once the necessary upgrades to the corridor are implemented, and an IC-UMS has been enabled within the corridor (including authorizing a corridor operator) 1115, the corridor airspace may be opened for UAS traffic and goods transport 1120 therethrough.

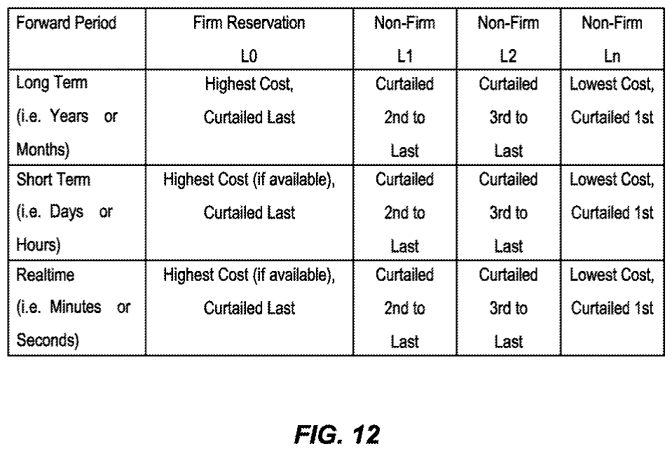

Depending on the market construct, Market Participants 1130_{A-N} may request various types of service, or throughput as indicated in the table of FIG. 12 via IC-UMS Market Corridor Operator 1125. Throughput would be granted by the Market Corridor Operator 1125 based on the determined available (safe) capacity of UAS traffic within the corridor.

In one example of an IC-UMS market 1100, a scenario of an infrastructure corridor airspace 1120 where the demand for UAS throughput exceeds the (safe) operating throughput capacity is provided. Under this scenario, a secure market portal, through which Market Participants 1130_{A-N} (whom have demonstrated creditworthiness, for example), is utilized by the Market Participants to submit requests for future UAS throughput in one or more infrastructure corridors within the purview of IC-UMS Market Corridor Operator 1125. In some specific embodiments, one or more Market Participants 1130_{A-N} may reserve long-term throughput capacity along one or more corridors for a period of time (e.g., hours, days, years, etc.), with the remaining capacity being delegated to the IC-UMS Market Corridor Operator 1125 which may then be reserved by one or more other Market Participants 1130_{A-N} based on requested one time use and availability (as discussed in more detail above). In one example embodiment, Market Participants 1130_{A} reserves 50% of the throughput capacity for one week of a first corridor, under the purview of IC-UMS Corridor Operator 1125, and the remaining 50% of the corridor capacity is open for Market Participants to bid for, for example, “day-ahead,” next day, or instantaneous throughput capacity in the infrastructure corridor airspace. Where demand exceeds capacity for a given period of time, Market Participants 1130_{A-N} requesting capacity during an excess request period may bid for the capacity (above a base cost for using the infrastructure corridor airspace during time periods where the demand does not exceed capacity). Revenue flows from the Market Participants 1130_{A-N}, through the IC-UMS Market 1125 operated by the Corridor Operator, and support the cost of operations and maintenance of the corridor, and in some embodiments the revenue may also be dispersed to support infrastructure owners' capital investment in modifying its infrastructure to enable operation of an infrastructure corridor airspace.

Identification of a bounded corridor with safe throughput limits for UAS traffic creates a subtractable resource, and there is high likelihood of demand for throughput exceeding the available supply at various points in time. An efficient approach to create an open access environment that operates within the maximum safe operating conditions of a corridor relies upon a market-based IC-UMS. A market-based IC-UMS creates a market around the allowed and available safe capacity of UAS traffic through an infrastructure corridor. Communicating use costs for corridors to UAS operators allows market forces to regulate corridor usage. With a market created, potential users of the corridor will have equal rights of access while maintaining safe and efficient use of the corridor.

In many embodiments, the market created by the market-based IC-UMS, and associated access to the airspace above infrastructure corridors, could be marketed based on the “dynamically” determined available safe capacity of the airspace and the financial willingness of commercial UAS owners to utilize the corridor. Under one IC-UMS market construct, the IC-UMS may send market signals based on a forward-looking basis or a near real-time basis, where the available safe capacity of the infrastructure corridor airspace is bid upon, and prices cleared on predetermined intervals. In areas where the volume of UAS traffic exceeds the determined safe capacity of the infrastructure corridor airspace, congestion fees may be added to better allocate available capacity for the most efficient use. Under a different IC-UMS market construct, capacity reservations within an infrastructure corridor airspace could be bid, and capacity within the corridor could be reserved. An IC-UMS may also enable the creation of new, safe, regulated infrastructure corridors where market forces warrant such development.

The table of FIG. 12 provides example IC-UMS constructs that could be established through the use of a market-based IC-UMS. These sample market products could include both firm and non-firm reservations and have a pre-defined merit order in which they are curtailed.

FIG. 12 is a table illustrating a number of example infrastructure corridor UAS traffic management system constructs which may be established via a market-based system, consistent with various embodiments of the present disclosure.

Although the market may be the normal mechanism for determining rights to use the space, it is expected that Extreme and Emergency conditions (see above on corridor ratings) might occur that require non-market solutions to maintain reliability of the IC-UMS or the adjacent areas. It is expected that the establishment of a primary market create any number of secondary markets that may increase liquidity of the system and provide opportunities for hedging and even signals for further IC-UMS infrastructure capital improvements.

Aspects of the present disclosure are directed to an Infrastructure Corridor UAS Management System. The Infrastructure Corridor UAS Management System (IC-UMS”) may contain one, all, or any combination of the following components:¹ Defined Airspace Dedicated for Unmanned Aerial Vehicles—Above, within or nearby certain ground-based infrastructure corridors and junctions; Communication—Planning, Construction, Maintenance & Operation of Equipment and Systems; Computing and Automation Software and Hardware—Planning, Construction, ¹Various other aspects of the present disclosure may also be directed to an Aerial Infrastructure Corridor Management System (“AICMS”). Moreover, while traffic may imply that there is more than one drone, various embodiments of the present disclosure may be readily applied to a BVLOS for a single drone.

Developing, Maintenance and Operation of Equipment and Systems; Power and Charging—Planning, Construction, Maintenance & Operation of Equipment and Systems; IC-UMS Operations—Systems and Trained Operators to Manage the System in coordination with the FAA; IC-UMS Ratings—Methodology, Planning, Certification, and Application of Maximum Safe Operating limits of air space for UAS flights; and IC-UMS Markets—Methodology, Planning, Certification and Application of Markets for IC-UMS.

While each of these components may have standalone benefits, the combinations of them bring particular advantages for improving safe implementation of UAS flights within an infrastructure corridor while also allowing commercial UAS traffic to more safely coexist with manned aircraft.

### Dedicated Airspace

The infrastructure corridors and junctions may consist of 3-dimensional, dedicated corridors in, for example, Class G airspace above infrastructure companies' facilities. All segments of the corridor and junctions may be subject to FAA approval and authority. Moreover, infrastructure corridors and junctions may also account for flight paths that are adjacent or within the relevant corridors. These airspace corridors may be any 3-dimensional shape, including but not limited, to a horizontally or vertically extruded oval, circle, rectangle, or polygon etc. The coordination of the existing airspace with the FAA will likely have a strong impact on the particular shape of the corridor. A plurality of junctions and corridors may collectively define the dedicated airspace of an IC-UMS.

### Additional Embodiments of IC-UMS Operations

The IC-UMS may provide the Corridor Operator with the ability to serve as a balancing authority. This may enable more direct communication with relevant regulatory agencies such as the FAA, FCC or NERC. As balancing authority, the Corridor Operator, through the IC-UMS and necessary telemetry, may have the ability to provide real-time accounting of UAS entrance to and UAS exit from each FAA approved infrastructure corridor airspace for the balancing area in which the IC-UMS is operating. The balancing authority function of the IC-UMS will allow for the safe operation of UAS traffic across the seams of individual balancing areas. This may be accomplished by creating multi-tier, or layered, balancing areas to manage the traffic across the seams of lower tier balancing areas (Diagram 2). These higher-level balancing authorities may serve as a system operator who may interact with Corridor Operators of individual, lower tier balancing authorities. The process of layering IC-UMS could be extended to larger balancing authorities to the extent practical. The ultimate layer is expected to be the FAA who presently manages all airspace including traditional commercial traffic.

### IC-UMS Ratings

Methodology & equipment to facilitate capacity ratings of multi-use corridors of dedicated UAS system corridors and junctions (e.g. IC-UMS) based on the maximum system operating limits.

Whereas technologies may enable the safe flight of individual UASs (e.g., flight near, across above and below power lines), safety concerns emerge with multiple UASs or fleets of UASs utilizing infrastructure corridors. UAS corridor ratings may be used for planning, marketing, and safely operating the corridors. The primary function of the corridor ratings may be to determine the quantity and type(s) of UASs that can operate in a dedicated corridor.

Corridor ratings may be calculated using Base Facilities, Normal Conditional Modifiers, and Extreme/Emergency Modifiers.

Base Facilities are typically static parameters used to determine an “ideal rating” for nominal conditions, some example based facilities include: Physical Air Space—Inclusive of required clearances; Communication Limiters—This can be bulk, fleet or individual communication limits that collective form a communication limit for a corridor; Compute Limiters—This can be a bulk, fleet, or individual limits that collectively form a compute limit to the corridor; Externality Limiters—This can include emissions like audible noise, radio-frequency emissions, GHGs, etc.; and Entry/Exit—A UAS or group of UASs ability to enter or exit a corridor.

Normal Conditional Modifiers create conditions that impact (positive or negative) the ratings and provide an actual rating for corridors. These conditional modifiers may be planned for in advance or adjusted in real-time with emerging conditions, including for example: Weather Conditions—Temperature, Wind, Precipitation, etc.; Equipment Conditions—Status, Loading, etc.; and Externalities—Long Term Maintenance on Underlying Infrastructure (Applies for UAS Corridors that are near, adjacent, cross or intersect utility corridors).

Extreme/Emergency Conditional Modifiers create conditions that impact (negative or positive), examples of such Extreme/Emergency Conditional Modifiers include: Environmental Conditions—Storms, Lightning, Tornados, Hurricanes, Blizzards, etc.; Major Compute or Communication Limits—e.g. failure of a navigational system, Information System or vital component, etc.; Security (National/Local)—Cyber Threats; and Externalities (Applies for defined UAS Corridors)—Emergence of physical barriers to safe UAS travel (e.g. Rock slide), and Restoration of Damaged Underlying Infrastructure.

The Base Facility capacity may be modified by the Normal Conditional Modifiers to develop ratings for facilities. These ratings will typically vary throughout the year. Extreme/Emergency Conditional modifiers could be applied anytime and may be sudden and of high magnitude. Extreme/Emergency Conditional Modifiers may impact the marketing functions of the ratings as scheduled traffic is substantially disrupted.

Any individual corridor rating might create an interface (aka “path”) rating for a single or group of corridors. Furthermore, any Base Facility, Normal Conditional Modifier, or Extreme Conditional Modifier might impact the ratings of single or multiple corridors including total system ratings. Management of binding areas in the system exemplifies the value of a multi-tier balancing authority.

### Specific Embodiments of UAS Corridor Ratings

The use of dedicated corridors (e.g. IC-UMS) for UAS air traffic creates a limited asset with undefined limits. The methodology for UAS corridor ratings provides a reasonable way to define these limits. This is unique in providing a broad and comprehensive view of safe flight in a defined region. Consideration narrowly focused on collision avoidance or individual UAS navigation fails to account for other factors that might limit overall UAS traffic. Additionally, to arrive at the most economically efficient use of corridors, e.g. what UASs can fly in a limited dedicated space, a rating is required to define the available resource so it can be marketed. Knowing and acting upon the capability in a particular corridor for UAS flight, i.e. the corridor rating, is essential for ensuring safe UAS flight. For example, not accounting for various UAS speeds might result in crippling inefficiencies when low-speed UASs clog limited airspace that could otherwise be have been put to much more efficient use by higher speed UASs. The combination of all or some parameters in Base Facilities, Normal Conditional Modifiers, and Extreme/Emergency yields an actionable limit that can be planned, priced and operated. Furthermore, this can be done in an economically efficient manner maximizing social benefits of UAS corridors.

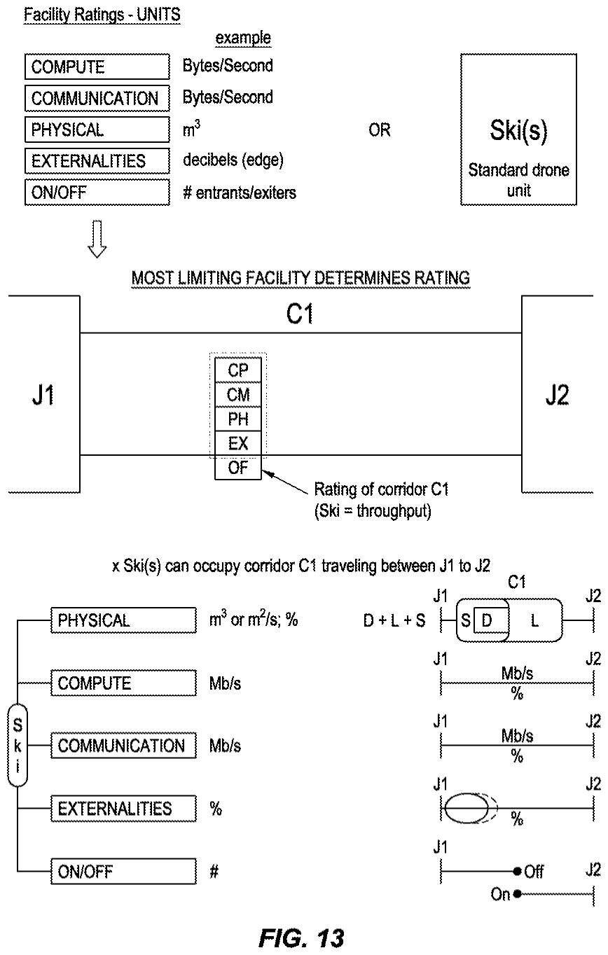

FIG. 13 is a diagram illustrating the use of facility ratings within an example infrastructure corridor UAS traffic management system, consistent with various embodiments of the present disclosure. In the embodiment of FIG. 13, limits are presented for the amount of safe UAS traffic a given corridor is capable of. These limits are quantifiable and can be determined using the attributes, or resources, of an established or planned corridor. Each of these corridor attributes are necessary to facilitate successful navigation of any number of UASs through a given corridor or junction. For example, and as shown in FIG. 13, from Junction #1 (J1) to Junction #2 (J2) utilizing Corridor #1 (C1). Various facility rating attributes are discussed in more detail below:

Physical—Limit on available volume of airspace for a given corridor. Physical airspace is necessary to prevent collisions or material degradation(s) to operability. In some specific embodiments, and shown in FIG. 13, the physical volume required by a UAS includes the UAS itself (D), a safety buffer around the UAS (S), and a leading edge of the UAS (L). Standard volume units may be used (e.g. cubic meters);

Compute—Limit on the maximum processing ability necessary to complete all navigational and other functions. Position within the corridor or junction is not expected to have a material impact on the resources of a corridor. This is inclusive of data storage, memory and processing and standard computing units may be used (e.g. bytes, hertz);

Communication—Limit on the maximum communication network(s) and cumulative data bandwidth to complete all navigational and other functions. Standard data communication units may be used (e.g. bytes per second, hertz, etc.);

Externalities—Limits on the maximum allowance of various externalities caused by UASs (e.g. audible noise). Since this industry is nascent, many of the laws and regulations around UAS operation have not been established and accordingly limits on allowed externalities are largely unknown. However, any limit regardless of when it is established may be incorporated as an externality limit. There may be absolute limits (e.g. maximum decibels of audible noise at a given distance) or there may be cumulative limits (e.g. audible noise that exceeds a certain amount of decibels for a duration of time);

Ingress/Egress—Limit on the maximum quantity of UASs that can enter into the corridor/junction and exit off the corridor/junction during a given period of time. To mitigate UAS flight interruptions which inhibit efficacy, flight planning and corridor reservations may be placed in advance. As this attribute enables the UAS traffic management system to forecast traffic volume along a corridor/junction, the system may forecast and/or impose additional burden on Physical, Compute, Communication resources and Externality allowances. Depending on the point of ingress/egress, a given UAS may only impact a portion of a corridor. The units may be maximum allowable quantity of ingress and/or egress per unit time (e.g. 40 units/minute).

Additionally, all the components could be containerized as a single new unit that summarizes all the resources and allowances (referred to as a “Ski” for simplification in this document) shown in FIG. 13. This allows for easier application in a market that facilitates route planning and operations through commoditization. The most limiting resource or allowance would determine the overall rating of a corridor or junction facility. A corridor or junction facility could be thought of as an operational service provider, i.e. a facility with capability to fulfill incoming service requests at a particular rate, and the rate of fulfilling requests could be one standard unit (i.e. ski) per unit time.

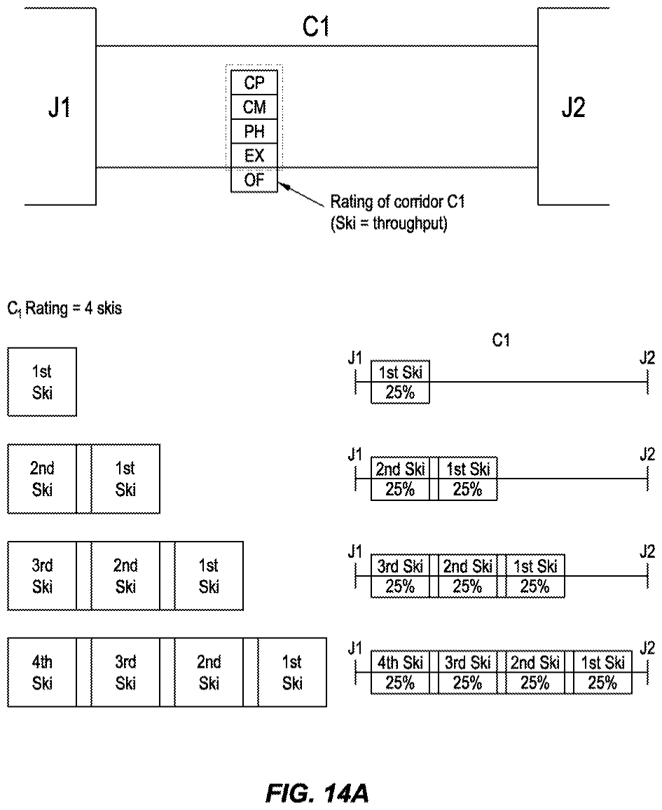

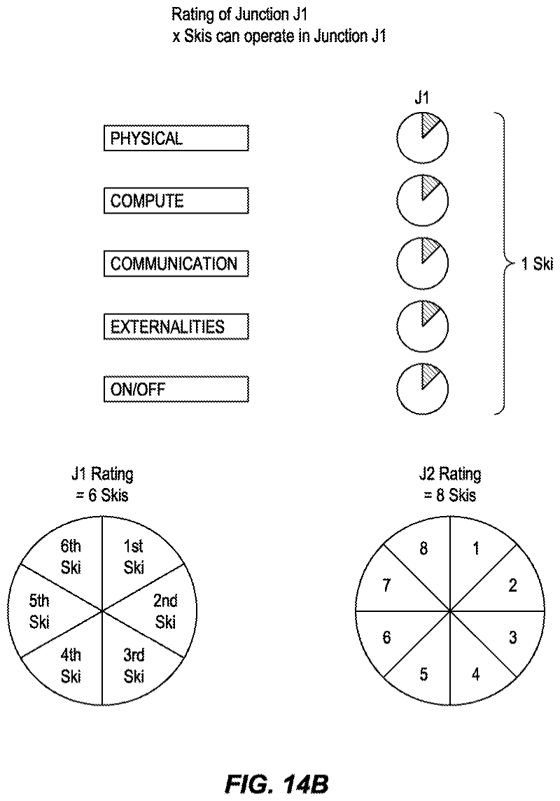

FIGS. 14A and 14B further illustrate diagrammatically the use of facility rating attributes to determine facility ratings within an example infrastructure corridor UAS traffic management system, consistent with various embodiments of the present disclosure. In the present embodiment, a corridor or junction facility may be compared to an operational service provider, i.e. a facility with capability to fulfill incoming service requests at a particular rate, and the rate of fulfilling requests may be one standard unit (or “ski”) per unit time. Each new service request reserves a portion of the facility while that request is being fulfilled. In the case of corridors, UAS requests may be dispatched sequentially from one junction to another junction across a corridor (e.g. From J1 to J2 across corridor C1, as shown in FIG. 14A). In an example with a corridor rating of 4 Ski (as shown in FIG. 14A), when four individual UASs are dispatched sequentially along the corridor and each UAS requires 1 Ski (25% of the capacity), the corridor is fully subscribed (100% of the 4 Skis Capacity) and no additional UASs may be allowed to enter the corridor. With reference to FIG. 14B, two junctions might have ratings of 6 Skis for J1 and 8 Skis for J2. In such an embodiment, as UASs are dispatched into the corridor up to the capacity of J1 each Ski of UASs would use up 16.7% of the capacity whereas for J2 it would only use 12.5% of the capacity for each Ski of UAS. This comparison of overall system capability is vital for planning and operational purposes of an infrastructure corridor UAS traffic management system.

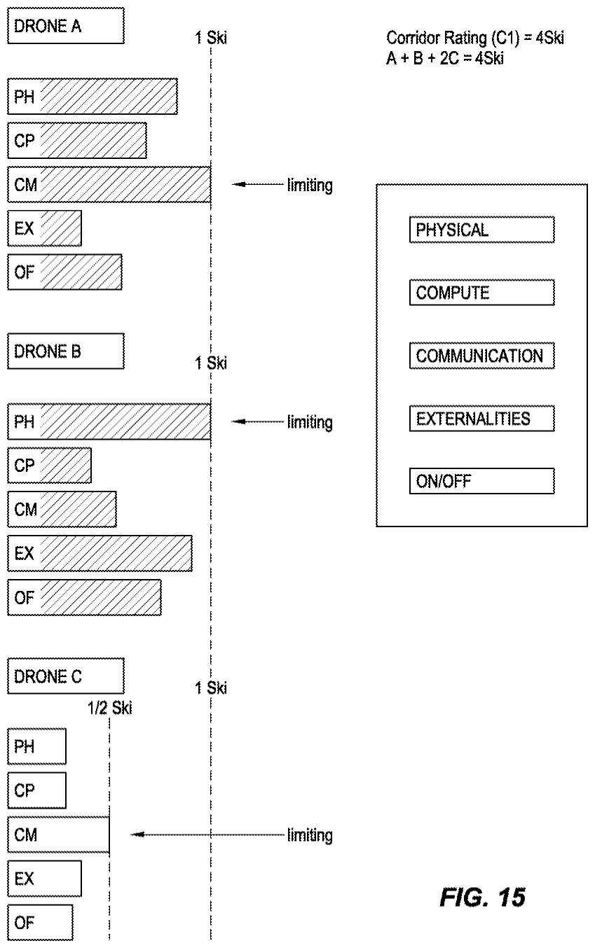

FIG. 15 is a diagram illustrating various facility rating attributes as determined for three example UASs, consistent with various embodiments of the present disclosure. When comparing various UASs, each has different demands of available resources for a corridor or junction. In order to determine the standard unit for UAS, the most limiting attribute determines the overall usage from a UAS. For example, UAS A (also referred to as “Drone A”) may have substantial Communication (CM) requirements as compared to physical (PH), compute (CP), externality (EX) and ingress/egress (OF). Accordingly, with respect to UAS A, the communication attribute is the most limiting and determinates that UAS A requires 1 Ski for operation. As shown further shown in FIG. 15, UAS B (also referred to as “Drone B”) require substantially more physical space than UAS A and is the most limiting factor—thereby determining that UAS B requires 1 Ski for operation. UAS C (also referred to as “Drone C”) however has very low requirements for most attributes, with the most limiting being communication—still only requiring ½ Ski.

When considering a corridor with a rating of 4 Ski many feasible combinations for UASs A, B and C exist. As long as (xA+yB+zC)=4 Ski, then it is feasible to operate all of these UASs simultaneously in the example corridor. For example, there would be 4A, with none of the others. Alternatively, there could be 4B with none of the others. And also, 8C with none of the others would be feasible. This could be further combined to 1A, 2B and 2C to achieve a fully subscribed facility at 100% of the 4 Ski rating. This matching of available resources in a corridor to required resources from the same or different UASs allows for planning and operational control of the system with safe and efficient flights for various UASs.

### Various Additional Embodiments of Market-Based IC-UMS

One key advantage to an IC-UMS is providing transparency and ensuring anti-competition measures can mitigate efforts by parties that may try to exert market power in the delivery of UAS transported goods. Although today it may be difficult to constrict all on-road deliveries to prevent other parties from using a particular transportation corridor, a free-for-all in the sky could enable such practices with massive gaming at severe social harm.

### Audible Noise Compliance Sensors

Devices mounted and connected to, in and around drone UAS corridors to measure the audible noise of UAS can better enable control of audible noise. UAS traffic within particular IC-UMS corridors will introduce additional noise, and compliance with noise limits will allow UAS to exist as better neighbors to individuals in close proximity to the UAS corridors. Audible noise sensors may be utilized at either the individual UAS level or at the corridor level. For example and in one embodiment, a corridor's audible noise sensors may be utilized to measure individual UAS' engines' outputs to ensure operation within a particular corridor's predefined collective UAS' noise emission limit. Whereas in this example, the corridor's audible noise sensor may measure and determine the collective audible noise at a point or points along the UAS corridor are approaching the audible noise limit, and as additional UAS enter the noise limited corridor, a signal may be communicated to individual UAS for UAS to make necessary adjustments to reduce the audible noise level in the corridor. Audible sensors could also be utilized to verify that individual UAS audible noise performance capabilities are as represented.

Various modules or other circuits may be implemented to carry out one or more of the operations and activities described herein and/or shown in the figures. In these contexts, a “module” is a circuit that carries out one or more of these or related operations/activities. For example, in certain of the above-discussed embodiments, one or more modules are discrete logic circuits or programmable logic circuits configured and arranged for implementing these operations/activities. In certain embodiments, such a programmable circuit is one or more computer circuits programmed to execute a set (or sets) of instructions (and/or configuration data). The instructions (and/or configuration data) can be in the form of firmware or software stored in and accessible from a memory (circuit). As an example, first and second modules include a combination of a CPU hardware-based circuit and a set of instructions in the form of firmware, where the first module includes a first CPU hardware circuit with one set of instructions and the second module includes a second CPU hardware circuit with another set of instructions.

Certain embodiments are directed to a computer program product (e.g., nonvolatile memory device), which includes a machine or computer-readable medium having stored thereon instructions which may be executed by a computer (or other electronic device) to perform these operations/activities.

Although several embodiments have been described above with a certain degree of particularity, those skilled in the art could make numerous alterations to the disclosed embodiments without departing from the spirit of the present disclosure. It is intended that all matter contained in the above description or shown in the accompanying drawings shall be interpreted as illustrative only and not limiting. Changes in detail or structure may be made without departing from the present teachings. The foregoing description and following claims are intended to cover all such modifications and variations.

Various embodiments are described herein of various apparatuses, systems, and methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” “an embodiment,” or the like, means that a particular feature, structure, or characteristic described in connection with the embodiment is included in at least one embodiment. Thus, appearances of the phrases “in various embodiments,” “in some embodiments,” “in one embodiment,” “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. An unmanned aerial system comprising:
a propulsion unit;
a navigation system communicatively coupled to the propulsion unit and configured and arranged to provide control inputs to the propulsion unit which affect navigation of the unmanned aerial system along an infrastructure corridor; and
a transceiver communicatively coupled to the navigation system and configured and arranged to
communicate a current position of the unmanned aerial system with a remote infrastructure corridor operator, and
receive navigational instructions from the corridor operator to facilitate navigation of the unmanned aerial vehicle relative to the corridor and other unmanned aerial systems operating within the infrastructure corridor.

2. The unmanned aerial system of claim 1, further including a magnetic field sensor configured and arranged to sense a magnetic field emanating from power lines within the infrastructure corridor; and
wherein the navigation system is communicatively coupled to the magnetic field sensor and is further configured and arranged to navigate the unmanned aerial system along the infrastructure corridor primarily using a signal from the magnetic field sensor indicative of a distance between the unmanned aerial system and the power lines.

3. The unmanned aerial system of claim 2, wherein the navigation system is further configured and arranged to determine a trajectory of the unmanned aerial system relative to the power lines based upon a change in the signal from the magnetic field sensor over time.

4. The unmanned aerial system of claim 2, further including a memory unit configured and arranged to store a preloaded map of a network of infrastructure corridors;
wherein the navigation system is communicatively coupled to the memory unit and is further configured and arranged to
retrieve the preloaded map of the network of infrastructure corridors, and
based upon the signal from the magnetic field sensor over time, associate the position and/or route of the unmanned aerial system with a location and/or route on the preloaded map of the network of infrastructure corridors.

5. The unmanned aerial system of claim 4, wherein the navigation system is further configured and arranged to analyze the signal from the magnetic field sensor over time to determine a location on the preloaded map of the network of infrastructure corridors associated with a unique magnetic signature.

6. The unmanned aerial system of claim 2, wherein the navigation system is further configured and arranged to determine a distance away from the power lines based upon the signal from the magnetic field sensor and a known power transmission characteristic of the power lines.

7. The unmanned aerial system of claim 6, wherein the known power transmission characteristic of the power lines is an electric field magnitude plot across the infrastructure corridor.

8. The unmanned aerial system of claim 6, wherein the known power transmission characteristic of the power lines is the voltage implied.

9. The unmanned aerial system of claim 1, wherein the navigation instructions from the corridor operator are indicative of when the unmanned aerial system may enter one or more corridors, or the route of corridors to be traversed between a present location and an intended destination.

10. The unmanned aerial system of claim 1, wherein the navigation instructions from the corridor operator are indicative of traffic along a corridor.

11. The unmanned aerial system of claim 1, wherein the magnetic field sensor is a primary input for the navigation system, the unmanned aerial system further including a beacon detector configured and arranged to detect beacons positioned along the infrastructure corridor indicative of a location within the infrastructure corridor; and
the navigation system is communicatively coupled to the beacon detector and is further configured and arranged to use a signal from the beacon detector as a secondary input for navigating the unmanned aerial system within the infrastructure corridor and between adjacent infrastructure corridors.

12. A method of operating an unmanned aerial system infrastructure corridor including the following steps:
localizing the position of a first plurality of unmanned aerial systems within the infrastructure corridor and a second plurality of unmanned aerial systems anticipated to enter the infrastructure corridor; and
providing navigational instructions to the first and second plurality of unmanned aerial systems with respect to access and transit through the infrastructure corridor.

13. The method of claim 12, further including the use of a plurality of overlapping balancing areas to monitor and control access and transit through a plurality of infrastructure corridors within an infrastructure corridor network by the first and second plurality of unmanned aerial systems.

14. The method of claim 12, further including tracking each unmanned aerial system as it enters, exits, and traverses through the infrastructure corridor.

15. The method of claim 12, wherein the step of localizing the position of the first plurality of unmanned aerial systems within the infrastructure corridor includes sensing a magnetic field at each of the first plurality of unmanned aerial systems to determine a relative position of the respect unmanned aerial system to power lines within the infrastructure corridor.

16. The method of claim 12, wherein the step of providing navigational instructions to the first and second plurality of unmanned aerial systems with respect to access and transit through the infrastructure corridor includes assigning each of the unmanned aerial systems to individual flightpath grid layers within a flightpath of the infrastructure corridor.

17. The method of claim 12, further including
operating the first and second plurality of unmanned aerial systems within the infrastructure corridor based on the navigational instructions received, and
temporarily deviating from the navigational instructions in response to obstacles within a flight path of a respective unmanned aerial system of the first or second plurality of unmanned aerial systems.

18. The method of claim 12, further including operating the unmanned aerial system infrastructure corridor with demand-based access pricing.

19. The method of claim 12, further including operating the unmanned aerial system infrastructure corridor with auction-based access when demand for infrastructure corridor access or throughput exceeds supply.
